(19) United States
(12) Patent Application Publication
(10) Pub. No.: US 2008/0013269 A1
(43) Pub. Date: Jan. 17, 2008

(54) NOTEBOOK COMPUTER WITH COMBINATION LOCK

(75) Inventors: SHIH-FANG WONG, Tu-Cheng (TW); WEN-HAW TSENG, Tu-Cheng (TW); LEI-TONG YU, Shenzhen (CN); LI LI, Shenzhen (CN); XIU-XUAN LI, Shenzhen (CN); YUN-TAO GAO, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/770,758

(22) Filed: Jun. 29, 2007

(30) Foreign Application Priority Data
Jul. 14, 2006 (CN) 200610061655.5

(51) Int. Cl. G06F 1/16

(52) U.S. Cl. 361/683

(57) ABSTRACT

A notebook computer is disclosed. The notebook computer includes a display unit, a main unit and a combination lock. The combination lock is mounted on the main unit, includes dials exposed on a front wall of the main unit, and defines a latch hole therein. A hook corresponding to the latch hole is mounted on the display unit. The combination lock is a reliable protection means for preventing information leakage when a user leaves the notebook computer for a while.

### BACKGROUND

1. Technical Field

The present invention relates to a notebook computer, particularly to a notebook computer with a combination lock.

2. General Background

When a notebook computer is in use, a user may leave the notebook computer for a while. The user may close the display unit for preventing information leakage. But others can open up the display unit and acquire the information in the notebook computer. The user may also set a password. After the display unit is opened, the display unit will not show any information until the password is entered. However, the password may be cracked and the protection to the information in the notebook computer is lost.

Therefore, what is needed is a notebook computer with a reliable protection means for the information in the notebook computer.

### SUMMARY

A notebook computer is disclosed. The notebook computer includes a display unit, a main unit and a combination lock. The combination lock is mounted on the main unit, includes dials exposed on a front wall of the main unit, and defines a latch hole therein. A hook corresponding to the latch hole is mounted on the display unit.

Further features and advantages will be provided or will become apparent in the course of the following detailed description.

### BRIEF DESCRIPTION OF THE DRAWINGS

FIG. 1 is a schematic, isometric view of a notebook computer with a combination lock according to a preferred embodiment of the present invention;

FIG. 2 is a schematic, exploded view of the notebook computer of FIG. 1; and

FIG. 3 is a schematic, enlarged view of the combination lock of the notebook computer of FIG. 1.

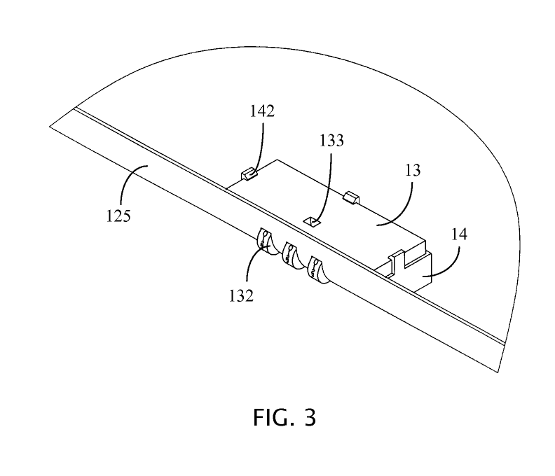

### DETAILED DESCRIPTION OF THE EMBODIMENT

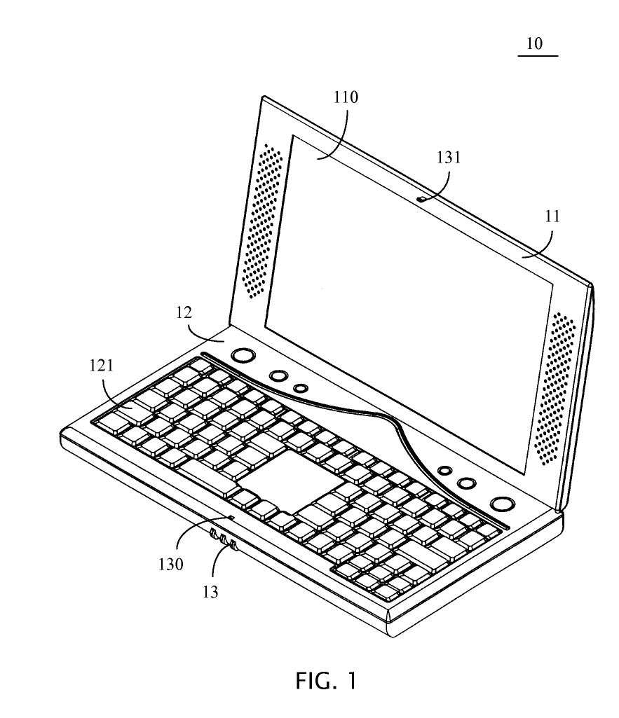

Referring to FIG. 1, a notebook computer according to a preferred embodiment of the present invention is disclosed. The notebook computer 10 includes a display unit 11 and a main unit 12. The display unit 11 includes a display screen 110 for showing information of the notebook computer 10.

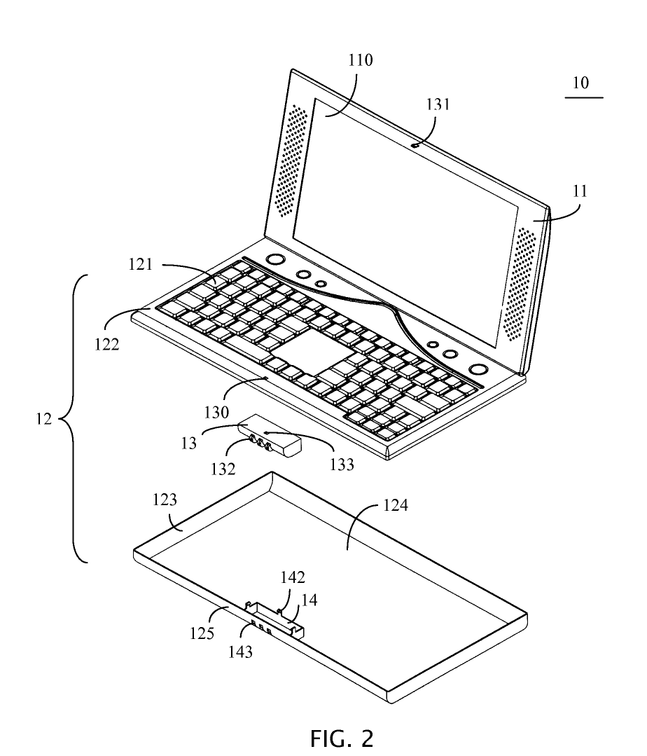

Referring to FIG. 2, the main unit 12 includes an upper cover 122 and a bottom cover 123. A keyboard 121 is mounted on the upper cover 122. The bottom cover 123 defines a cavity 124 for holding electronic components (not shown) such as a main circuit board, a hard disk, and so on.

In the cavity 124, a rectangular casing 14 is formed adjacent to a front wall 125 of the bottom cover 123. The casing 14 is configured for receiving a combination block 13. Elastic clips 142 extend upwardly from the casing 14, and each end of the elastic clips 142 is bend inwardly. The elastic clips 142 are configured for keeping the combination lock 13 in the casing 14. Three slots 143 are defined in the front wall 125. Dials 132 of the combination lock 13 pass through the slots 143 and are exposed outside the front wall 125. The combination lock 13 defines a latch hole 133 therein. The upper cover 122 defines a hole 130 corresponding to the latch hole 133. A hook 131 corresponding to the latch hole 133 and the hole 130 is mounted on the display unit 11.

If a user want to lock the notebook computer 10, he/she can close the notebook computer 10, thus the hook 131 is inserted into the latch hole 133. He/she then can rotate the dials 132 to a lock position. Therefore the notebook computer 10 is locked and a person who doesn't know the predetermined numbers of the combination lock 13 can't acquire information preserved in the notebook computer 10. If the user wants to use the notebook computer 10, he/she can rotate the dials 132 to an unlock position according to the predetermined numbers, open the notebook computer 10 and use it.

It is to be understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A notebook computer comprising:
a display unit;
a main unit;
a combination lock mounted on the main unit, comprising dials exposed on a front wall of the main unit, and defining a latch hole therein; and
a hook corresponding to the latch hole mounted on the display unit.

2. The notebook computer of claim 1, further comprising a casing mounted on the main unit, wherein the casing is configured for receiving the combination lock.

3. The notebook computer of claim 2, further comprising elastic pieces extended upwardly from the casing for keeping the combination lock in the casing.
